(19) United States
(12) Patent Application Publication
(10) Pub. No.: US 2014/0279651 A1
(43) Pub. Date: Sep. 18, 2014

(54) System and Method for Supply Chain Management

(71) Applicant: Pacific Logistics Corp., Pico Rivera, CA (US)

(72) Inventors: Douglas Hockersmith, Laguna Niguel, CA (US); Eric Hockersmith, Irvine, CA (US); Josh Kraft, Diamond Bar, CA (US)

(73) Assignee: PACIFIC LOGISTICS CORP., Pico Rivera, CA (US)

(21) Appl. No.: 14/204,940

(22) Filed: Mar. 11, 2014

Related U.S. Application Data
(60) Provisional application No. 61/799,076, filed on Mar. 15, 2013.

(51) Int. Cl. G06Q 10/08

(52) U.S. Cl. CPC G06Q 10/083
USPC 705/330

(57) ABSTRACT

A software system for supply chain management is disclosed. The system includes software operable to receive order data from an ordering device; receiving advance shipping notice data from a vendor device; determine that the advance shipping notice data meets certain criteria; generate and send an advance shipping alert to a receiving device; and generate and send a shipping request to a shipping device.

### CROSS-REFERENCE TO RELATED APPLICATIONS

This application claims the benefit of U.S. Provisional Application No. 61/799,076, filed Mar. 15, 2013, which application is hereby incorporated herein by reference in its entirety for all purposes.

### FIELD

The present disclosure relates generally to device networks and more particularly, but not exclusively, to systems and methods for providing a supply chain management system.

### BACKGROUND

For retailers that sell items sourced from a variety of vendors, supply chain management is cumbersome and difficult. Negotiating orders with each of the vendors, arranging shipping of the orders and coordinating receipt and processing of shipments is inefficient because the retailer, vendors, and shippers all have different systems, software and operating procedures, which requires specific communication and handling for each relationship. In addition to communication inefficiencies, it is difficult to control, modify and track orders for goods and to assure that these orders meet desired order and shipping criteria defined by the retailer. Unfortunately, ineffective communication results in, among other things, the retailer receiving incorrect goods; receiving ordered goods too late; receiving goods in a form that is difficult to process; and receiving goods at a time when the retailer is unprepared to receive and process the goods.

In view of the foregoing, a need exists for an improved system and method for supply chain management in an effort to overcome the aforementioned obstacles and deficiencies of conventional supply chain systems.

### BRIEF DESCRIPTION OF THE DRAWINGS

FIG. 1 is an exemplary top-level drawing illustrating a supply chain management system.

FIG. 2 is an exemplary data flow diagram illustrating an embodiment of a data flow path between the ordering device, receiver device, system server, vendor devices and shipping device of FIG. 1.

FIG. 3 is an exemplary block diagram illustrating an embodiment of a method for supply chain management in accordance with an embodiment.

FIGS. 4a-4d are exemplary drawings of a user interface in accordance with an embodiment, which may be used by a parent customer or ordering company.

FIGS. 5a-5g are exemplary drawings of a user interface in accordance with an embodiment, which may be used by a child customer or vendor.

### DETAILED DESCRIPTION

Since currently available shipping, purchase order, and inventory systems fail to provide for centralized and coordinated supply chain management, a supply chain management system that provides for shared data and alerts among ordering companies, vendors, and carriers can prove desirable and provide a basis for an improved and more efficient supply chain. This result can be achieved, according to one embodiment disclosed herein, by a supply chain management system 100 as illustrated in FIG. 1.

Turning to FIG. 1, the supply chain management system 100 is shown as including an ordering device 110, a receiver device 115, a system server 120, a first and second vendor device 130A, 130B and a shipping device 140 that are operably connected via a network 150. The receiver and ordering device 110, 115 may be associated and be part of an organization such as an ordering company 105. In an embodiment, the ordering device 110 and receiver device 115 may be operably connected via a local area network (LAN) (not shown) in addition to the network 150, and the LAN may be wired or wireless. In some embodiments, the ordering device 110 and receiver device 115 may be the same device. Additionally, the receiver device 115 may have the same capabilities as the ordering device (e.g., generating, tracking, and/or modifying purchase orders, shipments, advance shipment notices, or the like).

The devices 110, 115, 130, 140 are depicted as desktop or laptop computers, but in various embodiments, the devices 110, 115, 130, 140 may be any suitable device including a smart phone, tablet computer, gaming device, server, or the like without limitation. Additionally, the system server 120 may be any suitable device or may comprise a plurality of devices, or may be a cloud-based system. In various embodiments, the network 150 may comprise one or more suitable wireless or wired network, including the Internet, a local-area network (LAN), a wide-area network (WAN), or the like.

In various embodiments, there may be a plurality of the devices 110, 115, 130, 140. For example, there may be a plurality of ordering companies 105 that order products from one or more vendors. Some of the plurality of ordering companies may or may not order products from the same vendor. Additionally, in some embodiments, a vendor may also be an ordering company 105 and an ordering company 105 may be a vendor. Additionally, there may be one or more shipper or carrier that services orders among a plurality of ordering companies 105 and vendors.

The supply chain management system 100 can advantageously be configured to provide a shared database where purchase orders (POs), advanced shipping notices (ASNs) and shipping orders can be generated, shared and updated. Additionally, the supply chain management system 100 can provide for alerts to be selectively and automatically generated based on default or custom alert rules.

FIG. 2 is an exemplary data flow diagram illustrating an embodiment of a data flow path between the ordering device 110, receiver device 115, system server 120, a vendor device 130 and shipping device 140 of FIG. 1 in accordance with an embodiment. The data flow begins where the ordering device 110 generates an order, at 205, and sends the order to the system server 120, at 210. For example, in one embodiment, the ordering device 110 may generate an order via an interface, which may be a web-based interface hosted by the system server 120 or the like. In further embodiments, an ordering software program at the ordering device 110 may generate and send an order to the system server 120. Such an ordering software program may not be associated with an advance shipping notice software program on the system server 120. In embodiments having a plurality of ordering devices 110, ordering software programs may be different at different ordering devices 100, and orders sent to the system server 120 may be in different formats and of different protocols based on a given ordering software program. Accordingly, the system server 120 may be operable to identify and process various forms of orders that are sent or otherwise provided to the system server 120. Additionally, identifying and processing various forms of orders may occur automatically without user interaction. In other words, after an order is received at the system server 120, it may not be necessary for a user to process the order manually.

The order may be a purchase order (PO) or any suitable form of an order. In various embodiments, an order may include any information relevant to an order including a stock-keeping unit (SKU), one or more vendors, one or more shippers, one or more delivery locations, a number of units desired, a sub-description of a product (e.g., size, color, style, material, texture, or the like), a ship-by date, shipping instructions, contract terms, price per unit, and the like.

In some embodiments, orders may be automatically generated or prompted by a point-of-sale (POS) device or system (not shown), which may or may not be associated with the ordering company 105. For example, a retailer may have a POS system that keeps track of inventory at one or more retail location and/or one or more warehouse location. When tracked inventory for one or more product drops below a defined inventory threshold, an inventory alert may be generated and sent to the ordering device 110, which prompts an ordering user to place an order for more goods. However, in some embodiments, an order may be automatically generated and sent, without user interaction, when tracked inventory for one or more product drops below a defined inventory threshold.

An inventory threshold may apply to total inventory among a plurality of locations or may apply to certain locations. For example, an ordering company may have a west-coast and east-coast warehouse, and each warehouse may have a defined inventory threshold for various products. This may be desirable because such coastal warehouses may stock completely different retail locations and therefore product supply at the two warehouses may be independent. Accordingly, a given inventory threshold may automatically trigger an order specifying any suitable parameters. Referring to the coastal warehouse example, a west-coast warehouse inventory threshold for a given product may have a defined goods quantity threshold, re-order quantity, and shipping parameters (or the like without limitation) that is different compared to the east-coast warehouse.

Returning to the data flow of FIG. 2, the system server 120 processes the order, at 215, and in an optional step sends an order alert to the vendor device 130, at 220. Processing an order may include parsing data in the order and storing the order data in a database. In some embodiments, providing an order alert to the vendor device 130 may not be necessary because the presence of an order may already be anticipated by a vendor and the vendor device 130 may receive and obtain an order by request. For example, an ordering company 105 and vendor may be actively negotiating the terms of a given order and the vendor would anticipate an available order based on other communications with the ordering company 105.

In an embodiment, the vendor device 130 may access and view orders via an order portal 400 (FIGS. 5a-5g), which may comprise a webpage. For example, in an embodiment wherein a plurality of ordering companies use a given vendor, the vendor can view and access its orders via the order portal 400, and orders associated with other vendors may not be viewable or accessed. Referring to FIG. 2, the vendor device 130 can send an order request to the system server 120, at 225; and at 230, the system server 120 can retrieve one or more vendor orders associated with the requesting vendor device 130. The one or more vendor orders can be sent to the vendor device 130, at 235. Requesting, retrieving and receiving orders may be achieved via a webpage portal as discussed herein (e.g. via HTTP over TCP/IP); however, in some embodiments, any suitable requesting, retrieving and receiving method or protocol may be used.

At 240, the vendor device generates an advance shipping notice (ASN) and, at 245, the ASN is sent to the system server 120 where the ASN is processed, at 250. For example, the vendor device 130 may generate one or more ASNs in response to one or more POs that are received by the vendor device 130 as discussed herein. The vendor device 130 may generate, submit and modify an ASN via the order portal 400.

For example, when preparing an ASN related to a given PO, data regarding the PO may be auto-populated into the ASN form from a system server memory, which stores data obtained from POs received from an ordering device 110. Accordingly, the process of generating an ASN may be advantageously streamlined by reducing the required input to generate the ASN and by using the most current data related to a given PO. In various embodiments, any suitable data may be included in an ASN, which may include information about a given shipment, such as shipment weight, number of units, number of units per bundle, number of bundles per carton, and the like.

Processing of the ASN by the system server 120 may include saving and/or updating data related to an order and may include generating various requests and alerts, which may be based on various defined criteria. Additionally, a shipping request may be sent to the shipping device 140, at 255, where the shipping request is processed, at 260, by the shipping device 140. An advance shipping alert can be sent to the receiving device 115, at 265, and optionally sent to the ordering device 110, at 270. Processing the ASN may include determining if the ASN meets advance shipping notice criteria, advance shipping notice alert criteria, order criteria, shipping criteria, or the like, and if so alert data may optionally be sent to the ordering device 110, at 275, or any other suitable device. Alerts may be sent via any suitable method, which may include an alert on the order portal 400, an SMS text message, file transfer protocol (FTP) an e-mail or the like.

In an embodiment, a portion of an advance shipping alert, shipping request, or other message may be configured in a format or protocol which is operable for use by a system associated the ordering device 110, receiver device 115, vendor device 130, shipping device 140 or the like. For example, the shipping device 140 may be operatively connected to a shipping system that prepares and tracks shipments for the shipper. Alerts, messages or shipping requests sent to the shipping device 140 may accordingly be formatted to integrate directly with the shipping system so that user interaction is not required for sent data to be input into the shipping system. Similarly, the ordering device 110, receiving device 115 or ordering company 105 alerts may have an ordering system, and alerts messages or requests may be configured to integrate with such a system without user intervention or without substantial user intervention.

Additionally, in an embodiment, any of the devices 110, 115, 130, 140 may have permissions to modify a portion of data related to an order, PO, shipment, or the like. Modification of such data may trigger a set of alerts and requests. For example, a vendor device 130 may make a change to a shipment and indicate that the shipment weight and volume will be double, that the shipment will be delayed by one day, and that twice as many units will be shipped. Such a change may trigger an alert to the shipping device 140, so that the shipper may change its shipping schedule and modify how the shipment will be handled, if necessary. An alert may be sent to the receiver device 115, which is associated with a receiving warehouse of an ordering company 105, and the receiving warehouse can then change how the shipment will be received so that additional space and staff will be available on the revised day. Additionally, the ordering device 110, which may be associated with the purchasing department of an ordering company 105 may also receive an alert because the change made by the vendor may violate contract rules or PO rules defined the ordering company 105. The ordering company 105 may thereby be able to renegotiate or cancel the order based on the changed shipment.

In various embodiments, there may be default alert or request rules that can be changed or updated by one or more of the devices 110, 115, 130, 140 or system server 120. Such alert or request rules may be changed globally or applied to one or more specific groups. For example, an ordering company 105 may desire to receive alerts when one of its vendors has more than 10,000 units in a given shipment, and may change advance shipping notice alert criteria so that an advance shipping alert will be generated when the vendor generates an advance shipping notice indicating a shipment having more than 10,000 units. Alerts can relate to any suitable aspect of an order, PO shipment, or the like, and may include alerts related to price, number units, shipment volume, shipment weight, shipping date, or the like.

In some embodiments, the ordering device 110 may create rules that prohibit submission of an advance shipping notice (ASN) with given criteria. For example, the ordering company 105 may not want the vendor to be able to generate an ASN indicating more than 10,000 units in a given shipment. Accordingly, the ordering company 105 may define advance shipping notice criteria that only allows a vendor to generate shipments and send advance shipping alerts if a submitted advance shipping notice meets all of the defined criteria. Advance shipping notice criteria may comprise shipping criteria, order criteria, and the like.

Returning to the data flow of FIG. 2, in a further optional step, a received shipping alert may be sent from the receiver device 115 to the ordering device 110, at 280. For example, when a shipment is received at a warehouse, the contents of the shipment may be processed and inventoried and an alert may be sent to the ordering device 110 with data relating to the inventoried shipment. In some embodiments, a received shipment alert may include data corresponding to number of item units, number of item unit bundles, shipment dimensions, shipment weight, date and time of received shipment, and the like. At the ordering device 110, such shipment data may be compared to order data associated with the shipment; an advance shipping alert associated with the shipment; or alert data associated with the shipment. Such a comparison may be used to track inventory, generate new orders, alert a vendor of an error in a shipment, alert a shipper of an error in a shipment, or the like. In some embodiments, such an error alert may be generated and sent automatically without user interaction. In further embodiments, a received shipment alert may be sent to any other desired device including the system server 120, the vendor device 130 and/or the shipping device 140.

FIG. 3 is an exemplary block diagram illustrating an embodiment of a method 300 for supply chain management in accordance with an embodiment. The method 300 begins in block 310 where ASN data is received from a vendor device 130 and in decision block 315 a determination is made whether the received ASN data meets ASN criteria. If not, the ASN data is rejected in block 320 and revised ASN data is requested. For example, in an embodiment, the vendor may be inputting ASN data into a form on the order portal 400 (e.g., FIGS. 5a-5g) but may not be allowed to finalize or submit the ASN data because it does not meet ASN criteria. The vendor would be required to input ASN data that met ASN criteria before the finalized ASN data or form could be submitted. As discussed herein, ASN criteria may relate to various aspects of an order or shipment and may be defined by an ordering company device 110 or the like.

In some embodiments, submission of ASN data that does not meet ASN criteria can generate an alert that may be sent to the ordering device 110 or other desired device. For example, in addition to the vendor receiving an alert that input or submitted data does not meet ASN criteria, the ordering company 105 may also be notified of an attempt to submit a non-conforming ASN. This may be desirable because in response to the alert, the ordering company 105 may contact the vendor to discuss how to make the ASN conforming, or may be prompted to make an exception to ASN criteria or to change ASN criteria. An ordering company 105 may thereby change ASN criteria to better meet the needs of vendors or be prompted to provide vendors guidance in generating ASNs that conform to desired criteria.

Returning to the method 300, if the ASN data meets ASN criteria, then the method 300 continues to decision block 325 where a determination is made whether the ASN data meets alert criteria. As discussed herein, alert criteria may relate to various aspects of an order or shipment and may be defined by an ordering company device 110 or the like.

If the ASN data meets alert criteria, in block 330, one or more alerts are generated and sent, which may include sending to one or more of the devices 110, 115, 130, 140. In various embodiments, one or more generated and sent advance shipping alert may correspond to a portion of an advance shipping notice or order data. Generating and sending an alert (e.g., an advance shipping alert) may comprise determining a target receiver device 115 or ordering device 110 that should receive the alert, and this determination may be based on advance shipping notice data, order data, or the like.

In some embodiments, an alert may be sent via an advance shipping software program on the system server 120 to a receiver software program on the receiver device 115. Such software programs may or may not be associated or have similar data protocols. In various embodiments, a system server 120 may be operable to send alerts to receiver software programs on a plurality of receiver devices 115, where the receiver software program is different on some receiver devices 115 and the different receiver software programs use different protocols. Accordingly, in various embodiments, generating an advance shipping alert may include determining a target receiver software program and formatting the advance shipping alert based on the identified target receiver software program.

Additionally, generating and sending advance shipping alerts may occur automatically without user interaction. In other words, once a determination is made that a received advance shipping notification meets certain criteria, advance shipping alerts may then be sent automatically.

Returning to the method 300, of FIG. 3, in block 335, ASN data is stored and in block 340, a shipping request is generated and sent to the shipping device 140. The method 300 is done in block 399. In various embodiments, one or more generated and sent shipping request may correspond to a portion of an advance shipping notice or order data. Generating and sending a shipping request may comprise determining a target shipping device 140 that should receive the shipping request, and this determination may be based on advance shipping notice data, order data, or the like. A shipping request may correspond to a single order, a plurality of orders, a portion of a plurality or orders, or a portion of a single order.

In some embodiments, a shipping request may be sent via an advance shipping software program on the system server 120 to a shipper software program on the shipping device 140. Such software programs may or may not be associated or have similar data protocols. In various embodiments, a system server 120 may be operable to send shipping requests to shipper software programs on a plurality of shipper devices 140, where the shipper software program is different on some shipper devices 140 and the different shipper software programs use different protocols. Accordingly, in various embodiments, generating a shipping request may include determining a target shipper software program and formatting the shipping request based on the identified target shipper software program.

Additionally, generating and sending shipping requests may occur automatically without user interaction. In other words, once a determination is made that a received advance shipping notification (ASN) meets certain criteria, shipping requests may then be sent automatically.

FIGS. 4a-4d are exemplary drawings of a user interface 400 in accordance with an embodiment, which may be used by a parent customer or ordering company. FIG. 4a depicts a PO verification page wherein a list of POs can be viewed, sorted and selected. FIG. 4b depicts a popup window 410 which displays PO details when a PO is selected on the page depicted in FIG. 4a.

FIG. 4c depicts a PO Business logic page wherein ASN criteria, alert criteria, rules or the like can be created or modified. For example, in the order quantity limits field 420, ASN criteria can be created which rejects shipments that are outside the designated limits (e.g., 2% as depicted). Additionally, alert criteria may also be defined such that an alert is sent when shipments are outside the designated limits (e.g., 2% as depicted). Although a percentage limit is depicted in the example of FIG. 4c, limits such as a defined number of units, or the like, may be used. Other examples include, but are not limited to, pieces minimum, weight minimum, late shipment and non-PO shipments. FIG. 4d depicts a vendor or child customer list, which can allow an ordering company to modify, add or remove vendors or vendor profiles.

FIGS. 5a-5g are exemplary drawings of a user interface 400 in accordance with an embodiment, which may be used by a child customer or vendor. FIG. 5a depicts a shipments page wherein a vendor can view, track and modify its shipments. FIG. 5b depicts an ASN and shipment scheduling page wherein the vendor can define contact information, shipper information and consignee information. FIG. 5c depicts a further ASN and shipment scheduling page wherein the vendor can input shipping and ASN data. FIG. 5d depicts an enlarged and further view of the page depicted in FIG. 5c, which include a PO selection portion 510 and a detail entry portion 520. These fields may allow the vendor to select and use PO data to pre-populate an ASN and shipment data fields. FIG. 5e depicts a further ASN and shipment scheduling page wherein the vendor can input data for an ASN or shipment. In some embodiments, this data may be pre-populated based on one or more selected saved vendor profiles. FIG. 5f depicts a still further ASN and shipment scheduling page wherein the vendor can finalize an ASN and shipment request. FIG. 5g depicts a shipments page wherein a vendor can view, edit and track its shipments.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

What is claimed is:

1. A method for supply chain management comprising:
receiving advance shipping notice criteria;
receiving advance shipping notice alert criteria;
receiving order data from an ordering device;
receiving advance shipping notice data from a vendor device;
determining that the advance shipping notice data meets the advance shipping notice criteria;
determining that the advance shipping notice data meets the advance shipping notice alert criteria;
generating an advance shipping alert, the advance shipping alert corresponding to a portion of the advance shipping notice data and to a portion of the order data;
sending the advance shipping alert to a receiver device;
generating a shipping request, the shipping request corresponding to a portion of the advance shipping notice data and to a portion of the order data; and
sending the shipping request to a shipping device.

2. The method of claim 1, wherein the generating and sending the advance shipping alert to a receiver device occurs automatically without user interaction.

3. The method of claim 1, wherein the generating and sending the shipping request to a shipping device occurs automatically without user interaction.

4. The method of claim 1, wherein the generating and sending the shipping request to a shipping device and the generating and sending the advance shipping alert to a receiver device occurs automatically without user interaction.

5. The method of claim 1, further comprising:
generating a second advance shipping alert, the second advance shipping alert corresponding to a portion of the advance shipping notice data and to a portion of the order data; and
sending the advance shipping alert to an ordering device.

6. The method of claim 5, wherein the advance shipping alert is sent to the same ordering device that provided the order data.

7. The method of claim 1, wherein the order data defines a plurality of orders for goods.

8. The method of claim 7, wherein the shipping request comprises a portion of a plurality of the orders.

9. The method of claim 1, wherein the receiver device and ordering device are associated with the same ordering company.

10. The method of claim 1, further comprising determining a receiver device based on at least one of a portion of the advance shipping notice data and a portion of the order data, and wherein sending the advance shipping alert to a receiver device comprises sending the advance shipping alert to the selected receiver device.

11. The method of claim 1, further comprising determining a shipping device based on at least one of a portion of the advance shipping notice data and a portion of the order data; and wherein sending the shipping request to a shipping device comprises sending the shipping request to the selected shipping device.

12. The method of claim 1, wherein advance shipping notice criteria comprises at least one of:
at least one date when a shipment can be received;
at least one date when a shipment cannot be received;
at least one limit on number of item units;
at least one limit on weight of a shipment;
at least one limit on dimensions of a shipment;
at least one allowable shipment method; and
at least one set of allowable payment terms.

13. The method of claim 1, wherein advance shipping notice data comprises at least one of:
contents of a shipment;
weight of a shipment;
dimensions of a shipment;
number of item units within a shipment; and
number of item bundles within a shipment;

14. The method of claim 1, wherein sending the advance shipping alert to a receiver device comprises sending the advance shipping alert from an advance shipping software program to an unassociated receiver software program.

15. The method of claim 14, wherein generating the advance shipping alert comprises:
determining a target receiver software program; and
formatting the advance shipping alert based on the identified receiver software program.

16. The method of claim 1, wherein sending the shipping request to a shipping device comprises sending the shipping request from an advance shipping software program to an unassociated shipper software program.

17. The method of claim 16, wherein generating the shipping request comprises:
determining a target shipper software program; and
formatting the shipping request based on the identified shipper software program.

18. The method of claim 1, wherein advance shipping notice criteria comprises shipping criteria and order criteria.
